(19) United States
(12) Patent Application Publication
(10) Pub. No.: US 2025/0285024 A1
(43) Pub. Date: Sep. 11, 2025

(54) Method for Generating a Training Dataset

(71) Applicant: Robert Bosch GmbH, Stuttgart (DE)

(72) Inventors: Andreas Frischen, Leonberg (DE); Andreas Koelsch, Peiting (DE); Anke Giliard, Stuttgart (DE); Benjamin Moster, Niefern-Oeschelbronn (DE); Heiko Sgarz, Leonberg (DE); Jan Linus Steuler, Woelfersheim (DE); Leon Huschka, Aichtal (DE); Lukas Fiederer, Balingen (DE); Uwe Troeltzsch, Roesrath (DE)

(21) Appl. No.: 19/072,674

(22) Filed: Mar. 6, 2025

(30) Foreign Application Priority Data
Mar. 11, 2024 (DE) 10 2024 202 232.2

(51) Int. Cl. G06N 20/00; G01S 17/06

(52) U.S. Cl. CPC G06N 20/00; G01S 17/06

(57) ABSTRACT

A computer-implemented method for generating a training dataset to train an artificial intelligence for operating a measuring device, in particular a wall diagnostic device, includes (i) recording sensor data of at least one sensor unit of a measuring device, (ii) performing a position determination of the measuring device relative to the wall and generating position-specific sensor data using a position determination system, (iii) labeling the position-specific sensor data taking into account ground truth information and generating labeled sensor data, and (iv) aggregating the labeled sensor data into a training dataset. Also disclosed is a method for training an artificial intelligence.

This application claims priority under 35 U.S.C. § 119 to application no. DE 10 2024 202 232.2, filed on Mar. 11, 2024 in Germany, the disclosure of which is incorporated herein by reference in its entirety.

The present disclosure relates to a method for generating a training dataset for training an artificial intelligence for a wall diagnostic device. The disclosure furthermore relates to a method for training an artificial intelligence for a wall diagnostic device.

### BACKGROUND

Diagnostic devices for performing wall diagnostics and detecting objects formed in the walls are known from prior art.

It is an object of the present disclosure to provide an improved method for generating a training dataset for training an artificial intelligence of a wall diagnostic device, as well as an improved method for training such an artificial intelligence.

The object is achieved by the method set forth below. Advantageous embodiments are subject-matter also set forth below.

### SUMMARY

According to one aspect, a computer-implemented method is provided for generating a training dataset for training an artificial intelligence to operate a measuring device, in particular a wall diagnostic device, wherein the method comprises:
recording sensor data of at least one sensor unit of a measuring device, wherein the sensor data represents a wall to be diagnosed;
performing a position determination of the measuring device relative to the wall and generating position-specific sensor data using a position determination system, wherein position information is associated with each piece of sensor data recorded in the position determination, and wherein the position information defines a position of the measuring device relative to the wall, in which the measuring device was positioned relative to the wall at a time the sensor data was recorded;
labeling the position-specific sensor data taking into account ground truth information and generating labeled sensor data, wherein the ground truth information comprises at least one piece of information regarding a presence of the object in the wall; and aggregating the labeled sensor data into a training dataset.

This may achieve the technical advantage of providing an improved method for generating a training dataset to train an artificial intelligence to operate a measuring device, in particular a wall diagnostic device. For this purpose, sensor data is initially recorded using at least one sensor unit of a measuring device, in particular a wall diagnostic device. The recorded sensor data here depicts a wall to be diagnosed and, if present, objects disposed in the wall.

Further, a position determination of the measuring device relative to the wall is performed and position-specific sensor data is generated by a position determination system. The position-specific sensor data includes the information from the sensor data recorded and also includes position information, wherein the position information defines a position of the measuring device relative to the wall in which the measuring device was positioned at the time the sensor data was recorded.

Subsequently, the position-specific sensor data is labeled. This takes into account ground truth information. The ground truth information comprises at least one piece of information regarding a presence of the object in the wall. The ground truth information thus describes the actual presence of an object in the wall. The labeling of the position-bearing sensor data relates here to a labeling of the sensor data with respect to the respective presence or the position of the object.

By labeling, the sensor data is thus characterized at least in that the respectively marked piece of sensor data either depicts an object disposed in the wall or not. The position determination of the measuring device at the time the sensor data is recorded allows for labeling of the sensor data with respect to the presence of the object in the wall.

The ground truth information describes the locations in the wall at which the respective object is positioned. Mapping this information to the sensor data recorded by the measuring device requires position-specific information for the sensor data defining a position in which the measuring device was positioned at the time the sensor data was recorded.

By way of the corresponding labeled sensor data of the training dataset, artificial intelligence training of the measuring device, in particular the wall diagnostic device, is possible, in which the artificial intelligence is trained to detect an object disposed in the wall based on the sensor data of the measuring device. Detection includes detecting whether or not an object is disposed at a position on the wall.

According to one embodiment, the ground truth information comprises classification information regarding an object position and/or an object type of the object, and/or object depth information regarding an object depth within the wall, and/or object extension information regarding an object extension of the object.

By doing so, the technical advantage may be achieved that additional information may be incorporated into the training dataset by considering the additional classification information regarding the object position, the object type, the object depth information, and/or the object extension of the object. This additional information allows additional training of the artificial intelligence, which can thereby be trained to determine, based on the sensor data of the measuring device, an object position, an object type, an object depth and/or an object extension of the detected object.

In this case, the corresponding ground truth information describes the actual object position of the object in the wall, the actual object type of the object, the actual object depth of the object in the wall, and the actual object extension of the object, respectively.

The ground truth information indicated may be integrated into the training dataset or the recorded sensor data in the case of actual knowledge of the object disposed in the wall.

In the broadest sense of the application, the ground truth information describes the actual present state of the wall to be examined.

According to one embodiment, the position determination system comprises at least one camera sensor and at least one position mark, wherein the position mark is formed on a surface of the wall, wherein the camera sensor is arranged in a predefined perspective positioning towards the wall, and wherein determining the position of the measuring device relative to the wall comprises:
recording camera data of the camera sensor while recording the sensor data of the sensor unit of the measuring device, wherein the camera data depicts the measuring device positioned on the wall and the position marker disposed on the wall;
determining a relative position of the measuring device relative to the position marker based on the camera data; and
determining the position of the measuring device relative to the wall based on the relative position.

This may achieve the technical advantage that the position of the measuring device relative to the wall can be precisely determined. For this purpose, camera data of a camera sensor is first recorded. The camera data thereby depicts the measuring device disposed on the wall during the recording of the sensor data. Further, the camera data depicts a position marker formed on the wall. Thus, based on the camera data and taking into account the position marker, a time-resolved position of the measuring device relative to the position marker may be determined.

Finally, a time-resolved position of the measuring device relative to the wall can be determined based thereon. The procedure allows for precise positioning of the measuring device relative to the wall. Using the timestamps of the camera data, the position of the measuring device relative to the wall may be determined precisely for a plurality of times during recording of the sensor data by the measuring device.

The method in which performing the position determination further comprises:
performing a time synchronization between recording the sensor data of the sensor unit and recording the camera data of the camera sensor; and
determining the position information of the measuring device relative to the wall for each piece of sensor data of the sensor unit, taking into account the time synchronization.

This may achieve the technical advantage of enabling precise generation of the position-specific sensor data. By considering the timestamps of the camera data, the respective positions of the measuring device relative to the wall can be determined for a plurality of times. The time stamps of the sensor data may be used to determine the time at which a particular piece of sensor data was recorded by the measuring device. By synchronizing the timestamps of the sensor data and the camera data over time, the position of the measuring device relative to the wall at the time the sensor data was recorded can be determined for the sensor data being recorded. Thus, precise position information may be generated for each piece of recorded sensor data that defines where the measuring device was positioned at the time each piece of sensor data was recorded.

According to one embodiment, determining the position further comprises:
determining a perspective of the camera sensor relative to the wall based on the predefined perspective position in which the camera sensor is disposed relative to the wall;
performing a perspective correction on the relative position of the measuring device determined based on the camera data relative to the position marker to account for the perspective position of the camera sensor relative to the wall and determining the position of the measuring device on the wall based on the perspective correction.

This may achieve the technical advantage that, by considering the perspective of the camera sensor relative to the wall, a perspective correction of the camera data may be performed. The perspective correction may be used to clean up perspective-related distortions of the position determination of the measuring device relative to the wall based on the camera data. This allows for precise positioning relative to the wall based on the camera data.

According to one embodiment, the position marker is configured as an ArUco marker or a ChArUco marker.

This may achieve the technical advantage that the position marker configured as an ArUco mark or a ChArUco mark enables a precise determination of the relative position of the measuring device relative to the position marker based on the camera data. The ArUco marker or ChArUco marker may further be applied to the wall as a correspondingly configured marker without the need to modify the wall.

The ArUco marker or ChArUco marker known from the prior art may be used as an ArUco marker or ChArUco marker.

According to one embodiment, the position marker is formed by a marker formed on the wall and comprises: wallpaper patterns, light switches, outlets, windows, furniture.

This may achieve the technical advantage that elements already formed on the wall can be used as position markers. This may eliminate the need for external wall-mounted position markers.

According to one embodiment, the camera sensor is disposed on a positioning device, and wherein the camera sensor is positioned in the predetermined perspective position relative to the wall via the positioning device.

This may achieve the technical advantage that the camera sensor may be able to be disposed precisely in a predetermined perspective position relative to the wall by the positioning of the camera sensor of the positioning device. Because the perspective position is already specified and pre-defined, the necessary perspective corrections of the camera data can be reduced to a minimum. This facilitates the position determination of the measuring device relative to the wall based on the camera data.

According to one aspect, a training dataset for training an artificial intelligence of a wall diagnostic measuring device is provided, wherein the training dataset was generated by the method for generating a training dataset for training an artificial intelligence for operating a measuring device according to one of the preceding embodiments.

According to one aspect, a computer-implemented method for training artificial intelligence of a wall diagnostic measuring device is provided, comprising:
providing a training dataset by performing the method to generate a training dataset according to one of the preceding embodiments;
training the artificial intelligence based on the training dataset to perform object recognition of an object formed in a wall, wherein the object recognition comprises at least an object detection and an object classification.

Provided according to one aspect, is a computing unit configured to perform the method of generating a training dataset for training an artificial intelligence for operating a measuring device according to one of the preceding embodiments and/or the method of training an artificial intelligence of a measuring device.

Provided according to one aspect is a computer program product comprising instructions which, when the program is executed by a data processing unit, prompt it to perform the method for generating a training dataset for training an artificial intelligence to operate a measuring device according to one of the preceding embodiments, and/or the method for training an artificial intelligence of a measuring device.

### BRIEF DESCRIPTION OF THE DRAWINGS

Embodiments of the disclosure are described with reference to the following figures. The figures show:

FIG. 1 a schematic representation of a measuring device according to one embodiment;

FIG. 2 a further schematic representation of the measuring device according to a further embodiment;

FIG. 3 a further schematic representation of the measuring device according to a further embodiment;

FIG. 4 a schematic representation of a measurement of the measuring device according to one embodiment,

FIG. 5 a further schematic representation of the measuring device according to a further embodiment;

FIG. 6 a further schematic representation of the system for generating a training dataset according to a further embodiment,

FIG. 7 a schematic representation of data recorded by the measuring device;

FIG. 8 a further schematic representation of the system for generating a training dataset according to a further embodiment,

FIG. 9 a flowchart of a method for generating a training dataset according to one embodiment,

FIG. 10 a flowchart of a method for training an artificial intelligence of a measuring device according to a further embodiment, and

FIG. 11 a schematic representation of a computer program product.

### DETAILED DESCRIPTION

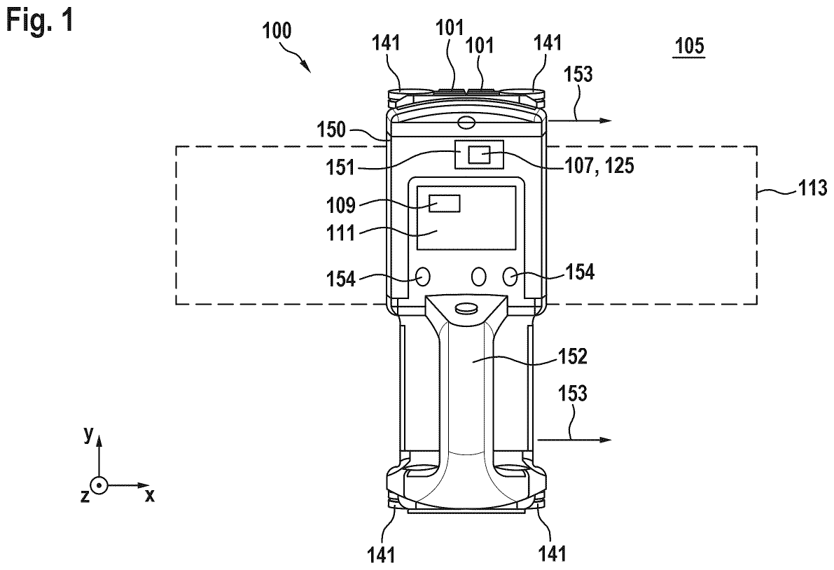

FIG. 1 shows a schematic representation of a measuring device 100 according to one embodiment.

The present disclosure relates to a measuring device, in particular a wall diagnostic device for examining walls 105 to be worked on. Wall diagnostic devices are known from the prior art that are used to detect objects located in walls. Such devices allow a user to examine walls to be worked on to search for objects located in the walls, in order to be able to perform planned work, for example drilling in walls, such that damage to the objects located in the walls can be avoided.

In the embodiment shown, the measuring device 100 comprises a housing 150 having a handle 152 for grasping of the measuring device 100 by a user, a display unit 111 for displaying diagnostic results 109 of the wall diagnostics, and controls 154 for switching the measuring device 100 between various operating modes.

According to the disclosure, the measuring device 100 comprises at least one radar sensor unit 101. By way of the radar sensor unit 101, radar signals may be transmitted towards the wall 105 to be examined, and radar signals reflected by the wall 105 may be received.

For example, the radar sensor unit 101 may be configured as a narrow band radar detector device in the 2.4 GHz to 2.4835 GHz frequency range or as an ultra-wide band radar detector device in the 1.8 GHz to 5.8 GHz frequency range.

The measuring device 100 further comprises a diagnostic module 107 executable on a computing unit 151 of the measuring device 100 to perform the wall diagnostics. The diagnostic module 107 is configured to perform corresponding diagnostics on the wall to be examined based on the radar data 103 of the radar sensor unit 101. The radar data 103 of the radar sensor unit 101 thereby depicts the wall 105 to be examined and, if applicable, objects 113 located within the wall 105.

The wall diagnostics carried out by the diagnostic module 107 comprise at least performing object recognition. The object recognition comprises an object detection and an object classification of the object 113 located in the wall 105. The object detection comprises at least the determination of an object position 115. The object position describes the positioning of the object located in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 located in the wall 105, are subsequently presented in a display unit 111 of the measuring device 100 to a user of the measuring device 100. For example, the display unit 111 may be configured as a corresponding display, and the diagnostic results 109 may be visually displayed. Additionally, the display of the diagnostic results 109 may be supported via audible and/or haptic signals. For example, the haptic signals may be realized via corresponding vibration signals.

The object 113 may be shown in the display, for example, by way of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: Concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105, and radar signals reflected from the wall 105 or the objects 113 located behind it are received, via the radar sensor unit 101. This radar data 103 of the radar sensor unit 101 is used by the diagnostic module 107 to perform the wall diagnostics described above and to determine corresponding diagnostic results 109.

For example, the diagnostic results 109 may comprise the object position 115 and/or object type 117 of the object 113 located in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to a user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be recorded for a plurality of different positions of the measuring device 100 relative to the wall 105. This enables a larger spatial area of the wall 105 to be examined than the effective range of the radar sensor unit 101. This enables objects 113 to be recorded that have a greater spatial extent than the effective range of the radar sensor unit 101.

While the measuring device 100 moves along the direction of movement 153, radar data 103 of the radar sensor unit 101 may be recorded continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-mentioned wall diagnostics based on the radar data 103 of the radar sensor unit 101 and to determine at least the object position 115 and the object type 117 of an object 113 located in the wall 105. The object classification or determination of the object type 117, respectively, comprises assigning the detected object 113 to predefined object classes.

The object classes may comprise: Metallic/non-metallic object, low voltage cable, single phase AC signal cable, multiphase AC signal cable, wood beam, metal beam, plastic pipe, water filled plastic pipe, for example fresh water pipe, non-water filled plastic pipe, for example waste water pipe, or other elements commonly installed in building walls.

Furthermore, the artificial intelligence 125 may be trained to determine the wall type 123 of the wall 105 to be examined at least based on the radar data 103 of the radar sensor unit 101. Possible wall types 123 may comprise: Concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by way of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, can be configured to perform wall diagnostics based on the radar data 103 of the radar sensor unit 101 and taking into account the additional sensor information of the further sensors described above. The additional information of the additional sensors mentioned above can particularly be used for object recognition of the objects 113 located in the walls 105. The additional sensor information may possibly provide improved detection of the objects 113 and may possibly provide improved classification of the objects 113.

For example, the material of the objects 113, for example as a metallic or non-metallic material, can be particularly improved and classified by using the additional sensor information.

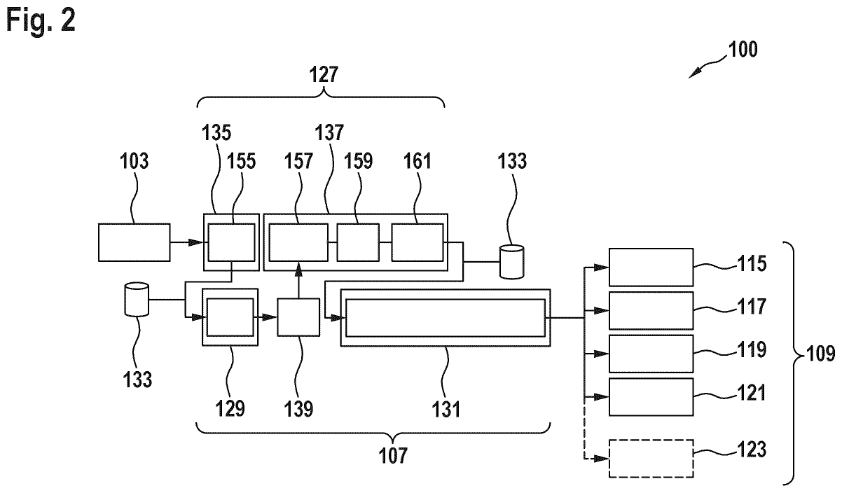

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing by the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 formed in the wall 105 to be examined and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be considered during the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. During the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects can occur on the radar data 103.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 133 performs object recognition of the object 113 located in the wall 105 to be examined and determines at least the object position 115 and the object type 117 of the respective object 113. Additionally, the object depth 119 and the object extension 121 may be determined by the object recognition module 131.

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed radar echoes of different frequencies may be used as radar data 103 and as input data for the diagnostic module 107. Alternatively, radar data 103 processed via multiple steps may be used. The pre-processing steps comprise, for example, the transformation of the signals from the frequency domain to the time or distance domain, background deduction, noise removal, and normalization of the signals. For radar data 103 which is available in the form of complex numbers, only the absolute value can be processed. Alternatively or additionally, the phase information may be considered.

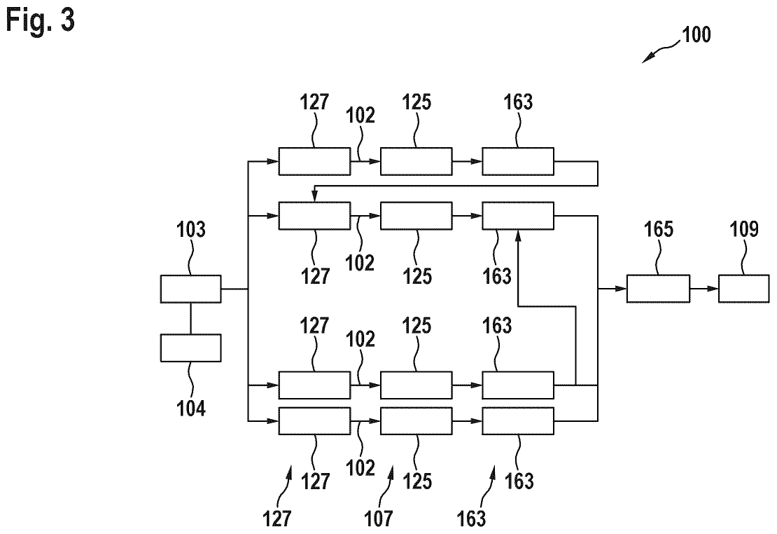

FIG. 3 shows a further schematic representation of the measuring device 100 according to a further embodiment.

In the embodiment shown, the diagnostic module 107 comprises a plurality of parallel processing paths 102. Each processing path 102 includes a pre-processing module 127, the diagnostic module 107, comprising the wall type classification module 129 and/or the object recognition module 131, for example, according to the embodiment in FIG. 2, and a post-processing module 163.

In FIG. 3, primarily the radar data 103 is shown as input data for the wall diagnostics. In addition to the radar data shown, however, the additional information from the additional sensors may also serve as input data for the wall diagnostics. The different information from the different types of sensors in the different parallel processing paths 102 can be processed and the corresponding wall diagnostics performed separately on the different sensor information. Upon completion of the wall diagnostics, a summary module may be used to assemble a summary of the individual partial analysis results for the diagnostic results 109 of the wall diagnostics.

Alternatively or additionally, different sub-aspects of wall diagnostics may be performed by the different processing paths 102 based on the same sensor information.

For example, the individual processing paths 102 may process different radar data 103 recorded during movement of the measuring device 100 relative to the wall 105 for different positions of the measuring device 100 relative to the wall 105. The radar data 103, thus representing different regions of the wall 105 and recorded sequentially in time as the measuring device 100 moves relative to the wall 105, may then be processed in the different processing paths 102 by the modules shown.

The various processing paths perform stand-alone wall diagnostics including at least determining the object position 115 and/or the object type 117 of the object 113 located in the wall 105.

By way of the summary module 165, the partial results of the stand-alone wall diagnostics of the different regions of the wall 105 provided in the individual processing paths 102 can be summarized to a contiguous diagnostic result 109. The contiguous diagnostic result describes the wall diagnostics of a contiguous spatial area that was scanned during movement of the measuring device 100 relative to the wall 105 and depicted by the corresponding recorded radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object 113 located in the wall can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may each be carried out. In the summary module 165, the various partial results of the wall diagnostics may be summarized into corresponding diagnostic results 109.

The diagnostic module 107 can be divided into different artificial intelligence structures 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligence structures 125, for example, neural networks. Alternatively, the various modules may form portions of an overall artificial neural network that are connected to an overall neural network according to structures known from prior art.

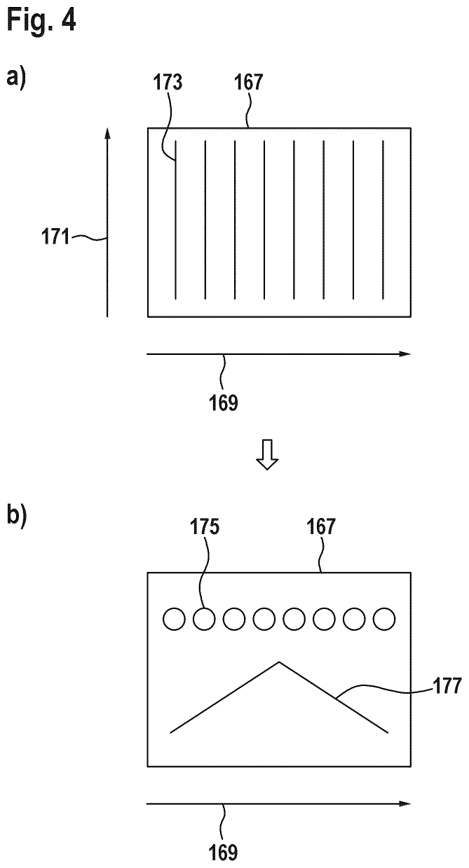

FIG. 4 shows a schematic illustration of a measurement by the measuring device 100 according to one embodiment.

For pre-processing, the radar data 103 or the additional sensor information 104 of the remaining sensors may be normalized, in particular to numerically stabilize the subsequent steps performed by the diagnostic module 107 during the wall diagnostics. For example, an amplitude and/or offset compensation may be performed for this purpose. Moreover, to reduce interference, filtering of the radar data 103 may be carried out, and to reduce the data rate, the corresponding sensor data may be sampled. Additionally, the radar data 103 or the additional sensor information 104 may be transformed into the respectively required frequency range or time range. Methods known from the prior art can be used for this purpose.

Furthermore, the recorded radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement by the measuring device 100 ends.

A rate of 2 to 20 windows per second of the data recording of the sensor data may be advantageous for this purpose. For spatial windows, the spatial sampling rates can be selected to achieve the desired local accuracy. Advantageously, 1 mm to 1 cm sampling rates can be used. This means that corresponding sensor data is recorded every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more sampling points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment in FIG. 2, the corresponding input data can comprise the respective pre-processed sensor data, i.e. radar data 103 and additional sensor information 104 of the additional sensors.

As stated above, the wall diagnostics may be performed by the diagnostic module 107 based on a correspondingly trained artificial intelligence. Alternatively, different processing paths may also be calculated by way of rule-based algorithms. In addition, within a processing path 102, a combination of artificial intelligence and rule-based algorithm is possible in the form of a parallel operation or concatenation.

The diagnostic results 109 of the wall diagnostics may be expressed as numeric values, vectors, or matrices. Furthermore, for the object detection, the probability of detection, or for the wall type classification and/or the object classification, respectively, a probability of the specified object classes and/or wall type classifications can be indicated. The same may apply to the position and/or depth determination, for which corresponding probability values can also be indicated.

In addition to the radar data 103, if the additional sensor information of the further sensor types is processed in a processing path 102, these may either be merged within the artificial intelligence 125 or combined by way of rule-based combinations.

During the post-processing of each processing path 102, of the embodiment in FIG. 3, multiple algorithm results based on multiple windows 167 may be summarized by the summary module 165. This summary can in particular be realized by way of majority formation, sum formation or also by multiplication of successive probability values.

Furthermore, by clustering multiple results, for example, it is possible to detect which objects, of multiple detected objects located close to one another, are the same object so that they are not incorrectly detected multiple times.

Likewise, it is possible to multiplicatively apply a weighting function 177 when summarizing the results from multiple windows 167. Advantageously, the diagnostic partial results 175 corresponding to corresponding data points in the space may be weighted with respect to positioning of the diagnostic partial results 175 relative to a center point of the respective window 167. This is illustrated by way of example in graph b), in which the individual diagnostic partial results 175 are weighted according to the weighting function 177 shown with respect to the center point of the window 167 shown.

According to one embodiment, the results of one processing path 102 after post-processing 163 may influence the extension of another processing path 102. Weighting parameters may be adjusted that may depend on the particular result from the processing path 102 for each window.

For example, the result of an object classification in which the object type 117 of an object located in the wall 105 is defined, can be used to increase the weight of a wall type classification, in which the wall type 123 of the respective wall 105 is determined, during the post-processing at locations without objects 113, because the respective radar data 103 at these locations is less influenced by reflections of the objects 113.

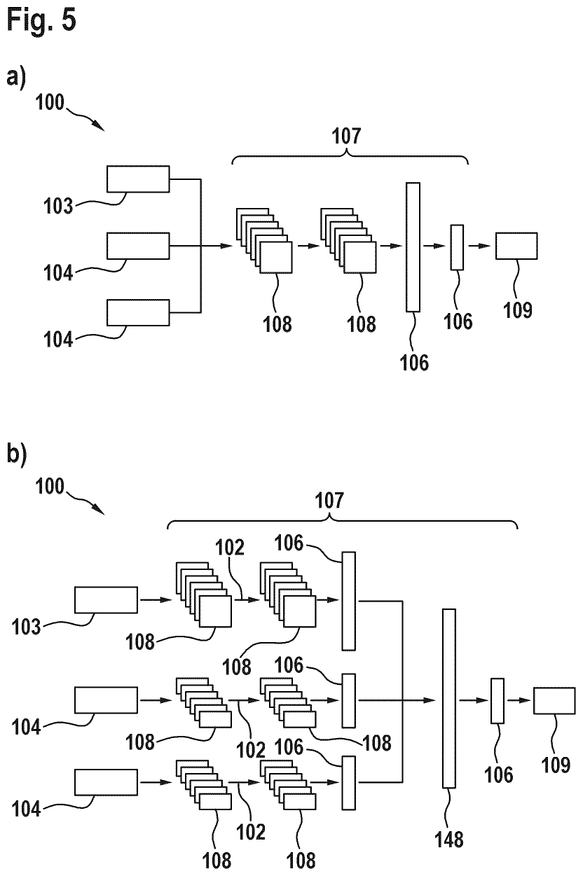

FIG. 5 shows a further schematic representation of the measuring device 100 according to a further embodiment.

Graphs a) and b) of FIG. 5 show two different alternatives of joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network. The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107 based on this.

On the other hand, in graph b) the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnostics of the different processing paths 102 are combined and fed to a final dense layer 106. The output data of the diagnostic module 107 corresponds to the diagnostic results 109 described above.

The correspondingly configured diagnostic module 107 is configured to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known from the prior art.

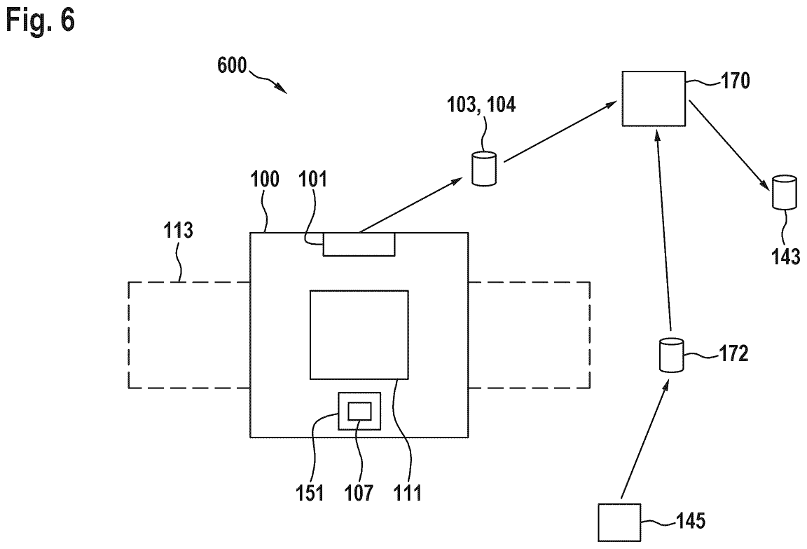

FIG. 6 shows a schematic representation of a system 600 for generating a training dataset according to one embodiment.

According to the present disclosure, to generate a training dataset 143, sensor data 103, 104 of at least one sensor unit 101 of the measuring device 100 is first recorded. For this purpose, several measurements can be taken by a measuring device 100 or by a plurality of measuring devices 100 of a wall 105 or a plurality of different walls 105. During the measurements 105, the measuring device 100 may be moved along the direction of movement 153 along the walls 105 to be examined and corresponding sensor data 103, 104 may be recorded, comprising the walls 105 to be examined and, if applicable, objects 113 disposed therein, as described above. Sensor data 103, 104 may include radar data 103 and/or additional sensor information 104.

During the recording of this sensor data 103, 104 by the measuring devices 100, position information 172 is determined for each measuring device 100 by a position determination system 145. The position information 172 describes the positions of the measuring device 100 relative to the wall 105 in which the measuring device 100 was positioned during the recording of the sensor data 103, 104.

The position information 172 may thereafter be integrated into the sensor data 103, 104 to generate position-specific sensor data thereon.

The sensor data 103, 104 may be labeled based on the position information 172, which defines the position of the measuring device 100 relative to the wall 105 at the time the respective sensor data 103, 104 was recorded for each piece of sensor data 103, 104. When labeling the sensor data 103, 104, each piece of sensor data 103, 104 is provided with ground truth information. The ground truth information relates to at least one piece of information indicating whether the respective sensor data 103, 104 represents the object 113 disposed in the wall 105.

This ground truth information depends, on the one hand, on whether an object 113 is disposed in the examined wall depicted by the respective piece of sensor data. Further, the ground truth information depends on whether the object 113 disposed in the wall 105 is disposed in an object position 115 that at least partially matches the position of the measuring device 100 relative to the wall 105 at the time the respective piece of sensor data 103, 104 is recorded.

Additionally, the ground truth information may further include information regarding an actual object location 115 of the object 113 and/or regarding an object type 117 of the object 113 and/or regarding an object depth 119 of the object 113 and/or regarding an object extension 121 of the object 113. Further, the ground truth information may include information regarding a wall type 123 of the examined wall 105.

Through labeling of the sensor data 103, 104 with respect to ground truth information, each piece of data is labeled with respect to the ground truth information, at least characterizing whether the respective piece of sensor data 103, 104 represents an object 113 disposed in the wall 105.

The labeling of the sensor data 103, 104 corresponds to a labeling of the sensor data 103, 104 with respect to the corresponding ground truth information.

The position information 172 of the position determination system 145 may clearly define for each piece of sensor data 103, 104 the location at which the measuring device 100 was positioned relative to the wall 105 at the time the respective piece of sensor data 103, 104 was recorded. If the actual object positions 115 of the objects 113 disposed in the wall 105 are known, this enables clear and unambiguous labeling of the sensor data 103, 104 with respect to the object position 115, i.e., whether an object 113 actually is depicted by the respective piece of sensor data 103, 104.

The sensor data 103, 104 labeled in this way is subsequently summarized in a corresponding training dataset 143.

Labeling the sensor data 103, 104 as well as considering the position information 172 and generating the training dataset 143 may be performed by an external computing unit 170.

For example, the position determination system 145 may comprise a position sensor disposed on the measuring device 100. A positioning of the measuring device 100 relative to the wall can thus be determined via the position sensor.

Preferably, the position determination system 145 comprises a camera sensor positioned externally to the measuring device 100. Camera data may be recorded via the camera sensor, which depicts the measuring device 100 while recording the sensor data 103, 104. A positioning of the measuring device 100 relative to the wall 105 while recording the sensor data 103, 104 can thus be determined via the camera data.

The position of the measuring device 100 relative to the wall 105 can be determined in a time-resolved manner via the timestamps of the camera data. The respective positions of the measuring device 100 relative to the wall 105 can thus be determined for a plurality of times. The time stamps of the sensor data 103, 104 may be used to determine the times at which the respective sensor data 103, 104 was recorded by the measuring device 100.

To determine the position information 172, a time synchronization of the camera data of the camera sensor and the sensor data 103 104 of the measuring device 100 can further be performed. By synchronizing the respective timestamps of the sensor data 103, 104 and the camera data in time, it can be achieved that the correct position information 172 can be associated with each piece of sensor data 103, 104.

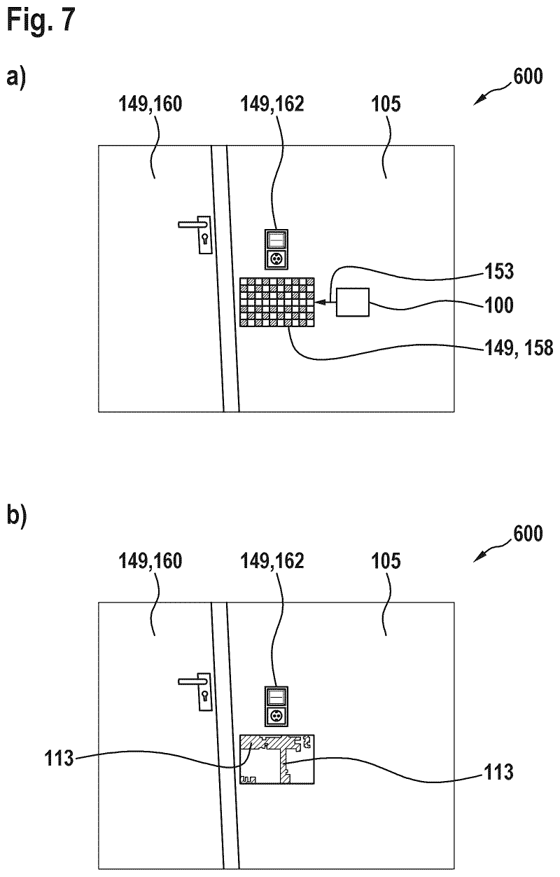

FIG. 7 shows a further schematic representation of the system 600 for generating a training dataset according to a further embodiment.

By way of example, graphics a), b) show two pieces of camera data, i.e. two images or two frames of the camera sensor 147 of the position determination system 145. The images shown in graphics a), b) depict a wall 105. A position marker 148 in the form of an ArUco/ChArUco marker 158 is disposed on the wall 105. Further, a light switch 162 is positioned on the wall, which is also defined as a position marker 148. A door 160 is disposed adjacent the wall 105, which is also defined as a position marker 148.

A measuring device 100 is also disposed in graphic a) in the sense of the present disclosure. The measuring device 100 may be moved along the direction of movement 153 to record corresponding sensor data 103, 104, so as to perform wall diagnostics for the area of the wall 105 over which the measuring device 100 travels as it moves through this spatial area.

According to one embodiment, the position information 172, i.e., the position determination of the measuring device 100 relative to the wall 105 while recording the sensor data can be carried out by using the location markers 148 shown in graphic a). Here, detection of the position marker 148 and the measuring device 100 in the camera data may be used to determine a position of the measuring device 100 relative to the position marker 148. The relative position determined between the measuring device 100 and the position marker 148 in this way allows the position of the measuring device 100 relative to the wall 105 to be determined. The position information 172 may be created based on this, respectively.

Graphic b) furthermore graphically represents a ground truth information regarding an object 113 disposed in the wall in the area of the position marker 148 positioned in the area of graphic a) in the form of the ArUco/ChArUco marker 158. The ground truth information includes at least the positioning of the object 113 in the wall 105.

In graphic b), a cable is indicated as an object 113. This is to indicate that the corresponding information, i.e., the object position 115, the object type 117, and other information regarding the object 113 is known as ground truth information.

Via the ground truth information shown, a corresponding labeling of the sensor data 103, 104 recorded by the measuring device 100 in the area of the ArUCo/ChArUco marker 158 shown in the area of graphic a) can be used to generate a corresponding training dataset.

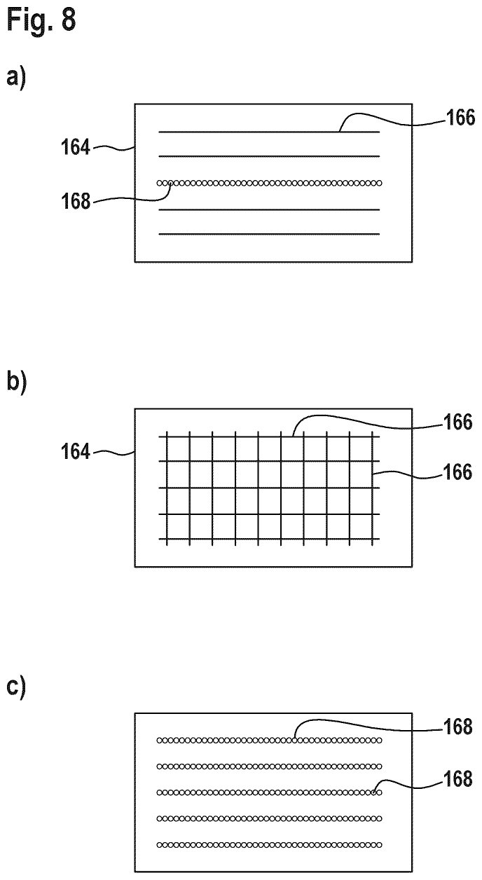

FIG. 8 shows a schematic representation of data recorded by the measuring device 100.

Graphics a), b), c) show different measurement surfaces 164 defining spatial areas where sensor data 103, 104 was recorded by moving the measuring device 100 relative to the wall 105. For example, the measurement surfaces 164 may describe the surface of the ArUco/ChArUco marker 158.

Within the measurement surface 164, the measuring device 100 is moved in multiple measurement paths 166 to record the sensor data 103, 104. Along the measurement paths 166, sensor data 103, 104 is recorded at different measurement points 168.

The measurement paths 166 may be arranged largely parallel to one another, as shown in graphic a). The measurement paths may also be arranged crossing one another, as shown in graphic b).

The position information 127 may be integrated with the sensor data 103, 104 recorded along the measurement path 166 at the measurement points 168 such that the respective sensor data 103, 104 at each measurement point 168 of the different measurement paths 166 is used to determine the position of the measuring device 100 to record the respective piece of measurement data 103, 104. If the measurement paths 166 intersect, the position information 162 already determined may be reused. Moreover, if the measurement points 168 are close together, the corresponding position information may be determined based on the position formations of the closely disposed measurement points 168.

Such fine mesh scanning of the measurement surface 164 in the measurement paths 166 shown may additionally generate a background correction based on the sensor data 103, 104 because the measurement points 168 are spaced close together with respect to one other. The background correction takes into account the measurement signals that are only reflected by the wall 105 and show no influence of an object disposed in the wall 105. An object determination can be carried out based on these in which the change in the recorded sensor data 103, 104 of the different measurement points 168 is determined.

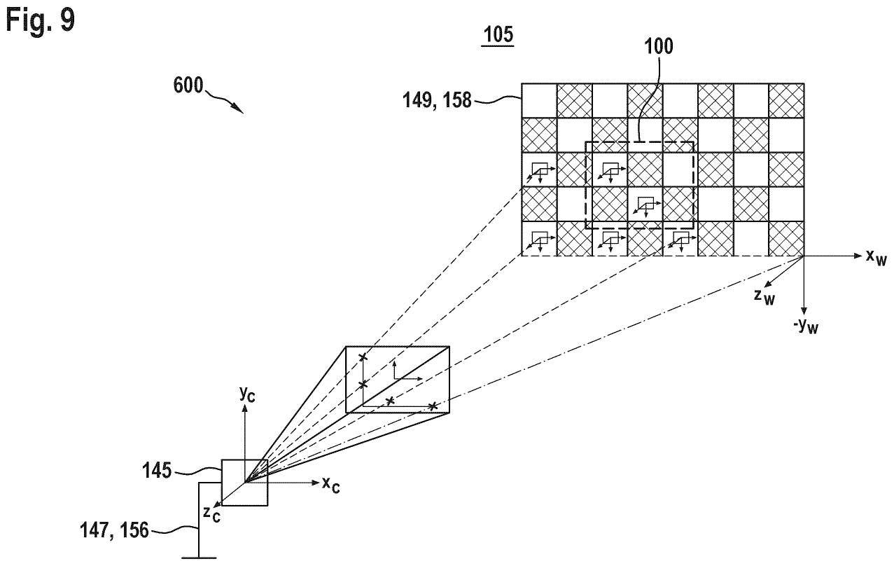

FIG. 9 shows a further schematic representation of the system 700 for generating a training dataset 143 according to a further embodiment.

In the embodiment shown, the position determination system 145 comprises a camera sensor 147. The camera sensor 147 is disposed on a positioning device 156. The positioning device 156, and in particular the camera sensor 147, are disposed a distance from the wall 105. A position marker 149 in the form of an ArUco/Ch ArUco marker 158 is disposed on the wall 105. Further, a measuring device 100 is shown in FIG. 9 on the wall 105 in the area of the ArUco/ChArUco marker 158.

FIG. 9 illustrates that, due to the distance of the camera sensor 147 from the wall 105, a perspective correction of the camera data recorded by the camera sensor 147 for determining the position of the measuring device 100 relative to the wall 105 must be performed.

A perspective correction may be performed by the mathematical relationships shown below.

$$[ \begin{matrix}u \\ \text{?} \\ 1\end{matrix} ] = E K {T}_{w}^{c} [ \begin{matrix}{X}_{w} \\ {Y}_{w} \\ {Z}_{w} \\ 1\end{matrix} ]$$

$$\text{?} \text{indicates text missing or illegible when filed}$$

Here, E is the unit matrix, K is the camera matrix, wherein the camera matrix comprises the intrinsic camera data of the camera sensor 147, and T is the transformation vector describing the transformation of a world coordinate system to a camera coordinate system of the camera sensor 147. The entries u and v represent pixel elements in the image plane. The components Xw, Yw, Zw represent the world coordinates of a world coordinate system. The components Xc, Yc, Zc represent the coordinates of the camera coordinate system of the camera sensor 147 shown in FIG. 9.

Taking the matrix notation into account results in the following equation:

$$[ \begin{matrix}u \\ \text{?} \\ 1\end{matrix} ] = [ \begin{matrix}1 & 0 & 0 & 0 \\ 0 & 1 & 0 & 0 \\ 0 & 0 & 1 & 0\end{matrix} ] [ \begin{matrix}\text{?} & 0 & \text{?} \\ 0 & \text{?} & \text{?} \\ 0 & 0 & 1\end{matrix} ] [ \begin{matrix}{r}_{11} & {r}_{12} & {r}_{13} & \text{?} \\ {r}_{21} & {r}_{22} & \text{?} & \text{?} \\ {r}_{31} & \text{?} & \text{?} & \text{?} \\ 0 & 0 & 0 & 1\end{matrix} ] [ \begin{matrix}{X}_{w} \\ {Y}_{w} \\ {Z}_{w} \\ 1\end{matrix} ]$$

$$\text{?} \text{indicates text missing or illegible when filed}$$

Here, f represents a focal length of the camera sensor 147, r represents elements of a rotation matrix R, and t represents elements of a translation vector. Subsequently, a transformation calculation can be carried out to obtain an actual position of the camera sensor 147 in the world coordinate system. The world coordinate system is represented by the ArUco/ChArUco marker 158. To convert vectors from the camera to the world system, the following transformation is required:

$${T}_{c}^{w} = {[ \begin{matrix}R & t \\ 0 & 1\end{matrix} ]}^{- 1} = [ \begin{matrix}{R}^{- 1} & - {R}^{- 1} t \\ 0 & 1\end{matrix} ]$$

Here, R is the rotation matrix. This correlation allows the real world position and location information of the camera sensor 147 to be extracted from the camera data in reference to an Aruco/ChArUco marker 158. The entire video or only individual frames of the camera data may be used for this purpose. Further, by a further vector-based transformation, it may be possible to determine the position and location of the
measuring device 100 depicted by the camera data. This results in an image-based vector relationship that is to be resolved by projection in 3D. To this end, positions or points from the camera data must be converted into positions with respect to the world coordinate system, from which the required vector is subsequently calculated. This is done through

$$[ \begin{matrix}{X}_{W} \\ {Y}_{W} \\ {Z}_{W}\end{matrix} ] = {R}^{- 1} ( {K}^{- 1} [ \begin{matrix}u \\ \text{?} \\ 1\end{matrix} ] - \vec{t} )$$

$$\text{?} \text{indicates text missing or illegible when filed}$$

Finally, one obtains vector x, which describes the transformation of projected positions of the measuring device 100 in the camera data to actual positions of the measuring device 100 in space, i.e. relative to the wall 105. This correlation is shown graphically in FIG. 9.

$${\vec{x}}_{{DC}_{w}} = [ \begin{matrix}{X}_{{D}_{w}} \\ {Y}_{{D}_{w}} \\ {Z}_{{D}_{w}}\end{matrix} ] - [ \begin{matrix}{X}_{{C}_{w}} \\ {Y}_{{C}_{w}} \\ {Z}_{{C}_{w}}\end{matrix} ]$$

Here, Cw are camera coordinates of the camera sensor 147 in the world coordinate system, Dw are device coordinates of the measuring device 100 in the world coordinate system, wherein the relation shown represents a conversion of the camera coordinates into the device coordinates of the measuring device 100. An accuracy of determining the position of the measuring device 100 relative to the wall 105 may in this procedure depend in a sensitive manner on the quality of a calibration of the camera sensor 147 and an unambiguous detection of the position marker. It may therefore be advantageous to calibrate the camera sensor 147 prior to performing the method and to take sufficient test images to ensure that the detection of the position marker is reliable.

By performing the method described above, the position of the measuring device 100 relative to the wall 105 may be determined at each point in time. This may be utilized to associate the sensor data 103, 104 recorded during measurements by the measuring device with these positions of the measuring device 100 relative to the wall 105. In particular, multiple measurements may be compiled into a measurement sequence and these may be advantageously be processed together.

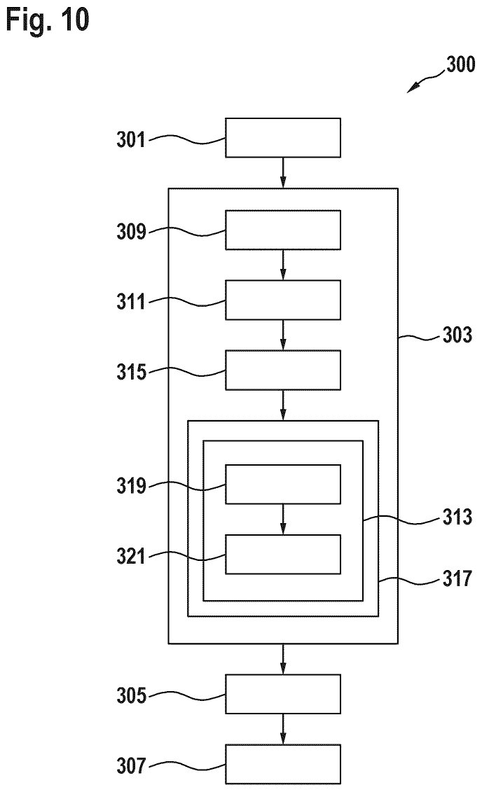

FIG. 10 shows a flowchart of a method 300 for generating a training dataset 143 according to one embodiment.

To generate a training dataset 143 for training an artificial intelligence 125 for operating a measuring device 100, in particular a wall diagnostic device, sensor data 103, 104 is initially recorded by at least one sensor unit 101 of the measuring device 100 in a first method step 301. The sensor data 103, 104 here depicts a wall 105 to be diagnosed.

In a further method step 303, a position determination of the measuring device 100 relative to the wall 105 is performed and position-specific sensor data 103, 104 is generated by a position determination system 145. In the position determination, each recorded piece of sensor data 103, 104 is associated with a piece of position information 172. The position information 172 defines a position of the measuring device 100 relative to the wall 105 at which the measuring device 100 was positioned relative to the wall 105 at a time of the respective piece of sensor data 103, 104.

According to one embodiment, the position determination system 145 comprises at least one camera sensor 147 and at least one position marker 149. The position marker 149 is formed on a surface of the wall 105 and the camera sensor 147 is disposed in a predefined perspective position with respect to the wall 105.

Thus, in a method step 309, camera data of the camera sensor 147 is first recorded during the time of recording of the sensor data 103, 104 by the measuring device 100, wherein the camera data depicts the measuring device 100 positioned on the wall 105 and the position marker 149 disposed on the wall 105.

In a method step 311, a relative position of the measuring device relative to the position marker 149 is determined based on the camera data.

In a method step 315, a time synchronization is subsequently performed between the recorded sensor data 103, 104 of the measuring device 100 and the recorded camera data of the camera sensor 147.

Following this, in a method step 317, a position information 172 in which the position of the measuring device 100 relative to the wall 105 at the time of recording a piece of sensor data 103, 104 is defined is determined for each piece of sensor data taking time synchronization into account.

Next, in a method step 313, a position of the measuring device 100 relative to the wall 105 is determined.

To do this, a perspective of the camera sensor 107 relative to the wall 105 based on the predefined perspective position of the camera sensor 147 relative to the wall 105 is determined in a method step 319.

Subsequently, in a method step 321, a perspective correction is performed based on the relative position of the measuring device 100, determined based on the camera data, relative to the position marker 149 to account for the perspective position of the camera sensor 147 relative to the wall 105.

In a further method step 305, the position-specific sensor data 103 is subsequently labeled taking ground truth information into account and labeled sensor data 103, 104 is generated. The ground truth information comprises at least information regarding the presence of at least one object 113 in the wall 105.

In a further method step 307, the labeled sensor data 103, 104 is aggregated to a training dataset 143.

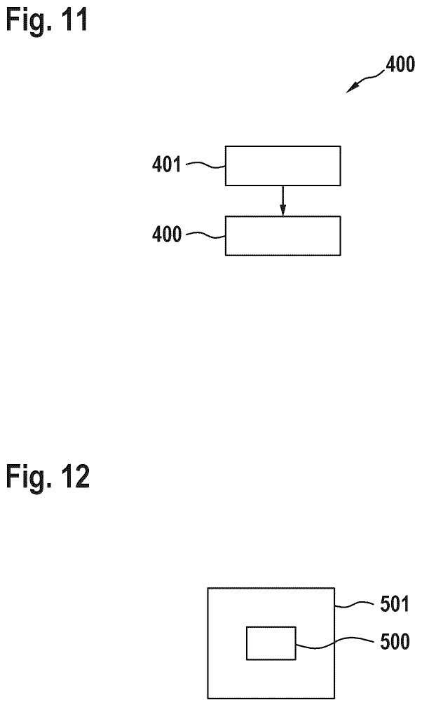

FIG. 11 shows a further flowchart of the method 300 for generating a training dataset 143 according to a further embodiment.

To train an artificial intelligence 125 of a wall diagnostic measuring device 100, a training dataset 143 is first provided in a method step 401 by performing the method 300 to generate a training dataset 143 according to the embodiments described above.

In a further method step 403, the artificial intelligence 125 is trained based on the training dataset 143 to perform an object recognition of an object 113 formed in a wall 105, wherein the object recognition comprises at least an object detection.

FIG. 12 shows a schematic representation of a computer program product 500 comprising instructions that, when the program is executed by a data processing unit, cause the latter to perform the method 300 for generating a training dataset 143.

In the embodiment shown, the computer program product 500 is stored on a storage medium 501. The storage medium 501 can in this case be any desired storage medium known from the prior art.

What is claimed is:

1. A computer-implemented method for generating a training dataset to train an artificial intelligence for operating a measuring device, comprising:
recording sensor data of at least one sensor unit of a measuring device, wherein the sensor data depicts a wall to be diagnosed;
performing a position determination of the measuring device relative to the wall and generating position-specific sensor data using a position determination system, wherein in the position determination, a position information is associated with each piece of recorded sensor data, and wherein the position information defines a position of the measuring device relative to the wall, in which the measuring device was positioned relative to the wall at a time the sensor data was recorded;
labeling the position-specific sensor data taking into account ground truth information and generating labeled sensor data, wherein the ground truth information comprises at least information regarding a presence of at least one object in the wall; and
aggregating the labeled sensor data into a training dataset.

2. The method of claim 1, wherein the ground truth information comprises classification information regarding an object location of the object and/or an object type of the object and/or object depth information regarding an object depth within the wall and/or object extension information regarding an object extension of the object.

3. The method of claim 1, wherein the position determination system comprises at least one camera sensor and at least one position marker, wherein the position marker is formed on a surface of the wall, wherein the camera sensor is disposed in a predefined perspective position with respect to the wall, and wherein performing the position determination for the measuring device relative to the wall comprises:
recording camera data of the camera sensor during the time the sensor data of the sensor unit is recorded by the measuring device, wherein the camera data depicts the measuring device positioned on the wall and the position marker disposed on the wall;
determining a relative position of the measuring device relative to the position marker based on the camera data; and
determining the position of the measuring device relative to the wall based on the relative position.

4. The method of claim 1, wherein performing the position determination further comprises:
performing a time synchronization between recording the sensor data of the sensor unit and recording the camera data of the camera sensor; and
determining the position information of the measuring device relative to the wall for each piece of sensor data of the sensor unit, taking into account the time synchronization.

5. The method of claim 1, wherein determining the position further comprises:
determining a perspective of the camera sensor relative to the wall based on the predefined perspective position in which the camera sensor is disposed relative to the wall; and
performing a perspective correction on the relative position of the measuring device determined based on the camera data relative to the position marker to account for the perspective position of the camera sensor relative to the wall and determining the position of the measuring device on the wall based on the perspective correction.

6. The method of claim 1, wherein the position marker is formed as an ArUco marker or a ChArUco marker.

7. The method of claim 1, wherein the position marker is formed by a marker formed on the wall and comprises: wallpaper patterns, light switches, outlets, windows, furniture.

8. The method of claim 1, wherein the camera sensor is disposed on a positioning device, and wherein the camera sensor is positioned via the positioning device in the predetermined perspective position relative to the wall.

9. A training dataset for training an artificial intelligence of a measuring device for wall diagnostics, wherein the training dataset was generated by the method for generating a training dataset for training an artificial intelligence for operating a measuring device according to claim 1.

10. A computer-implemented method for training an artificial intelligence of a wall diagnostic measuring device, comprising:
providing a training dataset by performing the method for generating a training dataset according to claim 1; and
training the artificial intelligence based on the training dataset to perform an object recognition of an object formed in a wall, wherein the object recognition comprises at least an object detection.

11. A computing unit configured to perform the method for generating a training dataset for training an artificial intelligence to operate a measuring device according to claim 1.

12. A computer program product comprising instructions which, when the program is executed by a data processing unit, prompt it to perform the method for generating a training dataset to train an artificial intelligence to operate a measuring device according to claim 1.

13. The method of claim 1, wherein the measuring device is a wall diagnostic device.

14. A computing unit configured to perform the method for training an artificial intelligence of a measuring device according to claim 10.

15. A computer program product comprising instructions which, when the program is executed by a data processing unit, prompt it to perform the method for training an artificial intelligence of a measuring device according to claim 10.
